(19) United States
(12) Patent Application Publication
(10) Pub. No.: US 2019/0287008 A1
(43) Pub. Date: Sep. 19, 2019

(54) MANAGEMENT APPARATUS, MANAGEMENT SYSTEM, AND MANAGEMENT METHOD

(71) Applicants: Akiyoshi NAKAI, Kanagawa (JP); Takuya MURATA, Tokyo (JP); Akiko TANABE, Kanagawa (JP)

(72) Inventors: Akiyoshi NAKAI, Kanagawa (JP); Takuya MURATA, Tokyo (JP); Akiko TANABE, Kanagawa (JP)

(21) Appl. No.: 16/351,688

(22) Filed: Mar. 13, 2019

(30) Foreign Application Priority Data
Mar. 19, 2018 (JP) 2018-051072

(51) Int. Cl. G06N 5/04

(52) U.S. Cl. CPC G06N 5/046

(57) ABSTRACT

A management apparatus for managing one or more devices includes circuitry to: acquire information indicating a use history of a device for each predetermined period; calculate, based on the acquired information indicating the use history, a predicted value indicating operation timing at which an operation is performed on the device; and output, based on the predicted value, an output value for the predetermined period. When an output value that is output for an (N−1)-th time is greater than a threshold, the circuitry outputs, as an N-th-time output value, the predicted value that is calculated for an N-th time. When the output value that is output for the (N−1)-th time is less than or equal to the threshold, the circuitry outputs, as the N-th-time output value, a value that is smaller than or equal to the output value that is output for the (N−1)-th time.

### CROSS-REFERENCE TO RELATED APPLICATIONS

This patent application is based on and claims priority pursuant to 35 U.S.C. § 119(a) to Japanese Patent Application No. 2018-051072, filed on Mar. 19, 2018, in the Japan Patent Office, the entire disclosure of which is hereby incorporated by reference herein.

### BACKGROUND

### Technical Field

The present invention relates to a management apparatus, a management system, and a management method.

### Description of the Related Art

In the related art, a prediction technique that remotely manages a use history of an apparatus (e.g., image forming apparatus) and predicts timing for a certain operation (e.g., timing for refilling consumables or timing for replacing components) has been known.

However, with the prediction technique of the related art, if the use history per unit period varies, a predicted value indicating operation timing (e.g., the number of remaining days until refilling of consumables) is increased or decreased. Thus, an operator fails to perform operation of the apparatus being managed at appropriate operation timing and is sometimes forced to do inefficient operation, such as refiling consumables after running out or replacing components after breakdown.

### SUMMARY

Example embodiments of the present invention include a management apparatus for managing one or more devices, including circuitry to: acquire information indicating a use history of a device for each predetermined period; calculate, based on the acquired information indicating the use history, a predicted value indicating operation timing at which an operation is performed on the device; and output, based on the predicted value, an output value for the predetermined period. When an output value that is output for an (N−1)-th time is greater than a threshold, the circuitry outputs, as an N-th-time output value, the predicted value that is calculated for an N-th time. When the output value that is output for the (N−1)-th time is less than or equal to the threshold, the circuitry outputs, as the N-th-time output value, a value that is smaller than or equal to the output value that is output for the (N−1)-th time.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating an example of a system configuration of a management system;

FIG. 2 is a diagram illustrating an example of a hardware configuration of a management apparatus according to a first embodiment;

FIG. 3 is an illustration for explaining an example operation of predicting a capacity from a use history of a device;

FIG. 4 is an illustration for explaining an example operation of calculating a predicted number of remaining days;

FIGS. 5A and 5B illustrate examples in which the predicted number of remaining days varies;

FIG. 6 is a diagram illustrating a functional configuration of the management apparatus according to an embodiment;

FIG. 7 is a flowchart illustrating flow of a process in which the management apparatus according to the first embodiment outputs the number of remaining days;

FIG. 8 illustrates a specific example of the process for outputting the number of remaining days;

FIG. 9 is a flowchart illustrating flow of a process in which the management apparatus according to a second embodiment outputs the number of remaining days;

FIG. 10 is a flowchart illustrating flow of a process in which the management apparatus according to a third embodiment outputs the number of remaining days;

FIG. 11A is a flowchart illustrating flow of a process for calculating the number of device use days, and FIG. 11B is a table used for calculating the number of device use days;

FIG. 12 is a flowchart illustrating flow of a process in which the management apparatus according to a fourth embodiment outputs the number of remaining days;

FIG. 13 is a flowchart illustrating flow of a process in which the management apparatus according to a fifth embodiment outputs the number of remaining days;

FIG. 14 is a flowchart illustrating flow of a process in which the management apparatus according to a sixth embodiment outputs the number of remaining days;

FIG. 15 is a flowchart illustrating flow of a process in which the management apparatus according to a seventh embodiment outputs the number of remaining days; and

FIG. 16 illustrates examples in which the management apparatuses according to the embodiments output the number of remaining days.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

### First Embodiment

### System Configuration of Management System

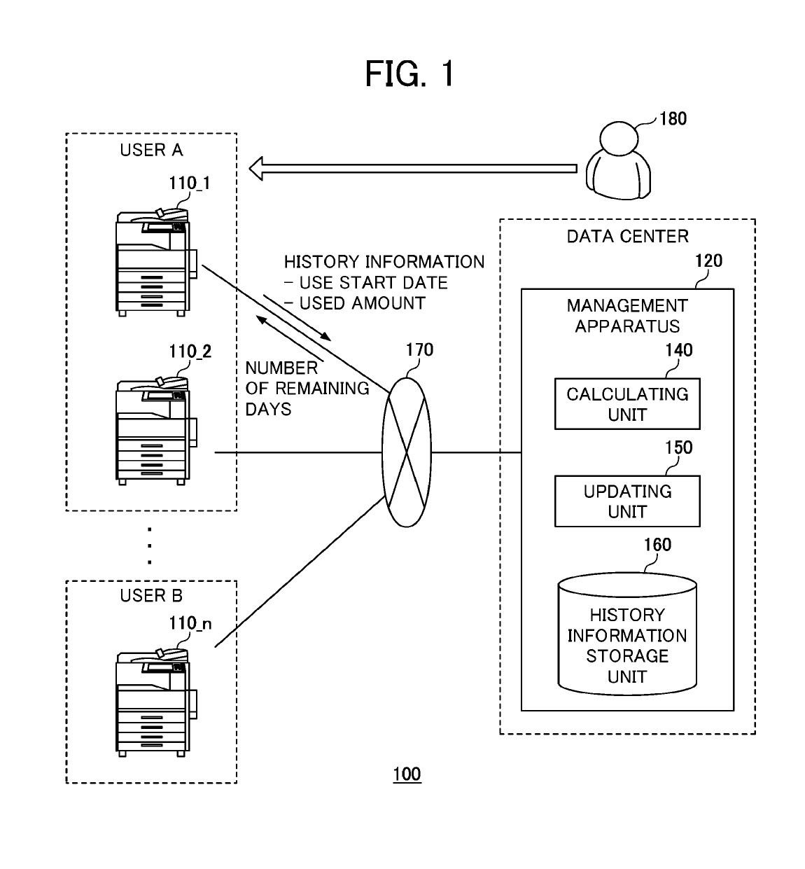

First, a system configuration of a management system including a management apparatus according to a first embodiment will be described. FIG. 1 illustrates an example of the system configuration of a management system 100. As illustrated in FIG. 1, the management system 100 includes devices 110_1 to 110_n and a management apparatus 120. In this embodiment, the devices 110_1 to 110_n and the management apparatus 120 are connected to each other via a network 170 so that communication can be performed therebetween.

Each of the devices 110_1 to 110_n is a device to be managed such as an image forming apparatus and includes consumables and components to be replaced. Each of the devices 110_1 to 110_n transmits history information to the management apparatus 120, and the history information indicates a use history of the consumables and components. The history information includes the date on which use of a corresponding one of the devices 110_1 to 110_n was started (use start date), a used amount of the consumables and components from the start of use, and a history of measured values or the like.

In addition, each of the devices 110_1 to 110_n receives the number of remaining days from the management apparatus 120. The number of remaining days is an output value that is output from the management apparatus 120. Specifically, the number of remaining days indicates the number of remaining days until refill timing for refilling consumables of a corresponding one of the devices 110_1 to 110_n or the number of remaining days until replacement timing for replacing components of a corresponding one of the devices 110_1 to 110_n.

It is assumed that the device 110_1 and the device 110_2 are installed in a working space of a user A, and the device 110_n is installed in a working space of a user B in the example in FIG. 1. Examples of the users include a company, a local government, and the like.

An operator 180 is an operator who performs various operations of the devices 110_1 to 110_n, such as refiling consumables or replacing components of the devices 110_1 to 110_n. For example, at the time of refiling consumables or replacing components of the device 110_1 or the device 110_2 installed in the working space of the user A, the operator 180 visits the user A and performs the operation (refill or replace). The operator 180 judges whether to visit the user based on an output value (number of remaining days) that is output from the management apparatus 120 installed in a data center.

The management apparatus 120 is an apparatus that acquires the history information from the devices 110_1 to 110_n to remotely manage the use history of the devices 110_1 to 110_n, and the management apparatus 120 outputs the number of remaining days. A management program is installed in the management apparatus 120, and when the program is executed, the management apparatus 120 serves as a calculating unit 140 and an updating unit 150.

The calculating unit 140 acquires the history information from the devices 110_1 to 110_n via the network 170 and stores the history information in a history information storage unit 160. Based on the acquired history information, the calculating unit 140 calculates a predicted number of remaining days (predicted value) indicating operation timing for various operations, such as timing for refilling consumables and timing for replacing components of the devices 110_1 to 110_n.

The updating unit 150 sends a notification of the timing (prediction timing) at which the calculating unit 140 calculates the predicted number of remaining days. In addition, if the calculating unit 140 sends a notification of the predicted number of remaining days in response to the notification of the prediction timing, the updating unit 150 determines whether the predicted number of remaining days is to be output as the number of remaining days.

If it is determined that the predicted number of remaining days is to be output as the number of remaining days, the updating unit 150 outputs the calculated predicted number of remaining days as the number of remaining days and transmits the predicted number of remaining days to a corresponding device. On the other hand, if it is determined that the predicted number of remaining days is not to be output as the number of remaining days, the updating unit 150 calculates an alternative number of remaining days, and outputs the calculated alternative number of remaining days as the number of remaining days and transmits the alternative number of remaining days to a corresponding device.

### Hardware Configuration of Management Apparatus

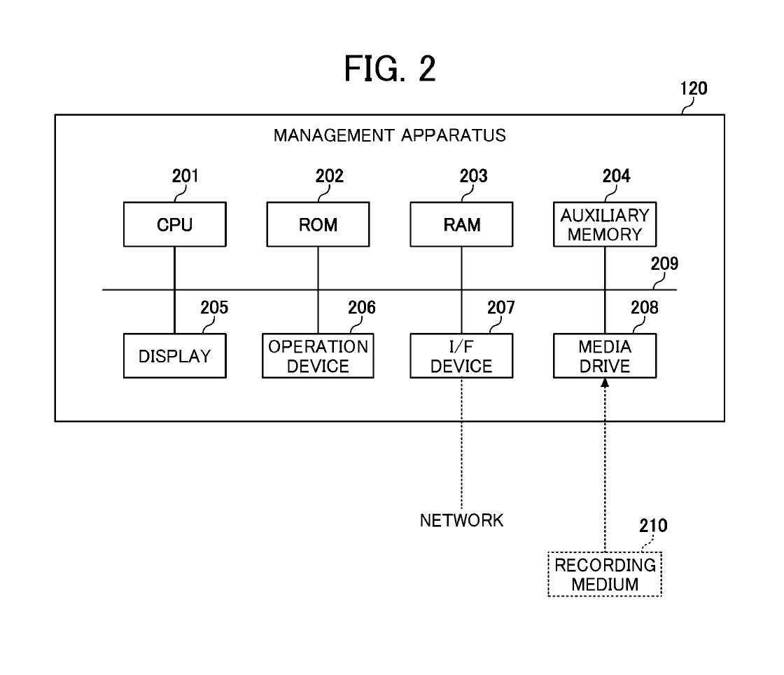

Next, a hardware configuration of the management apparatus 120 will be described according to the embodiment. FIG. 2 illustrates an example of the hardware configuration of the management apparatus 120.

As illustrated in FIG. 2, the management apparatus 120 includes a central processing unit (CPU) 201, a read-only memory (ROM) 202, and a random access memory (RAM) 203. The CPU 201, the ROM 202, and the RAM 203 form a so-called computer.

In addition, the management apparatus 120 also includes an auxiliary memory 204, a display 205, an operation device 206, an interface (I/F) 207, and a media drive 208. The hardware components of the management apparatus 120 are connected to each other via a bus 209.

The CPU 201 is an arithmetic device that executes programs (e.g., management program) installed in the auxiliary memory 204.

The ROM 202 is a non-volatile memory. The ROM 202 serves as a main memory device that stores programs, data, and the like that are used by the CPU 201 to execute the programs installed in the auxiliary memory 204. Specifically, the ROM 202 serves as a main memory device that stores, for example, a boot program for basic input/output system (BIOS) or extensible firmware interface (EFI).

The RAM 203 is a volatile memory such as a dynamic random access memory (DRAM) or a static random access memory (SRAM). The RAM 203 serves as a main memory device that provides a work area in which the programs installed in the auxiliary memory 204 are loaded when the CPU 201 executes the programs.

The auxiliary memory 204 is an auxiliary memory device that stores programs or information used when the programs are executed. For example, the history information storage unit 160 is realized in the auxiliary memory 204.

The display 205 is a display device that displays, for example, an internal state of the management apparatus 120 and displays, in the first embodiment, the number of remaining days as an example. The operation device 206 is an input device used when instructions are input to the management apparatus 120. The I/F 207 is a connection device for connecting the management apparatus 120 to the network 170.

The media drive 208 is a device in which a recording medium 210 is set. The recording medium 210 herein includes a medium that optically, electrically, or magnetically records information, such as a compact-disk read-only memory (CD-ROM), a flexible disk, or a magneto-optical disk. In addition, the recording medium 210 may also include, for example, a semiconductor memory that electrically records information, such as a ROM or a flash memory.

In this embodiment, the programs to be installed in the auxiliary memory 204 are installed in the following manner. For example, the recording medium 210 that has been distributed is set in the media drive 208, and the programs recorded in the recording medium 210 are read by the media drive 208. Alternatively, the programs to be installed in the auxiliary memory 204 may be installed by being downloaded from the network 170 through the I/F 207.

### Operation of Predicting Capacity

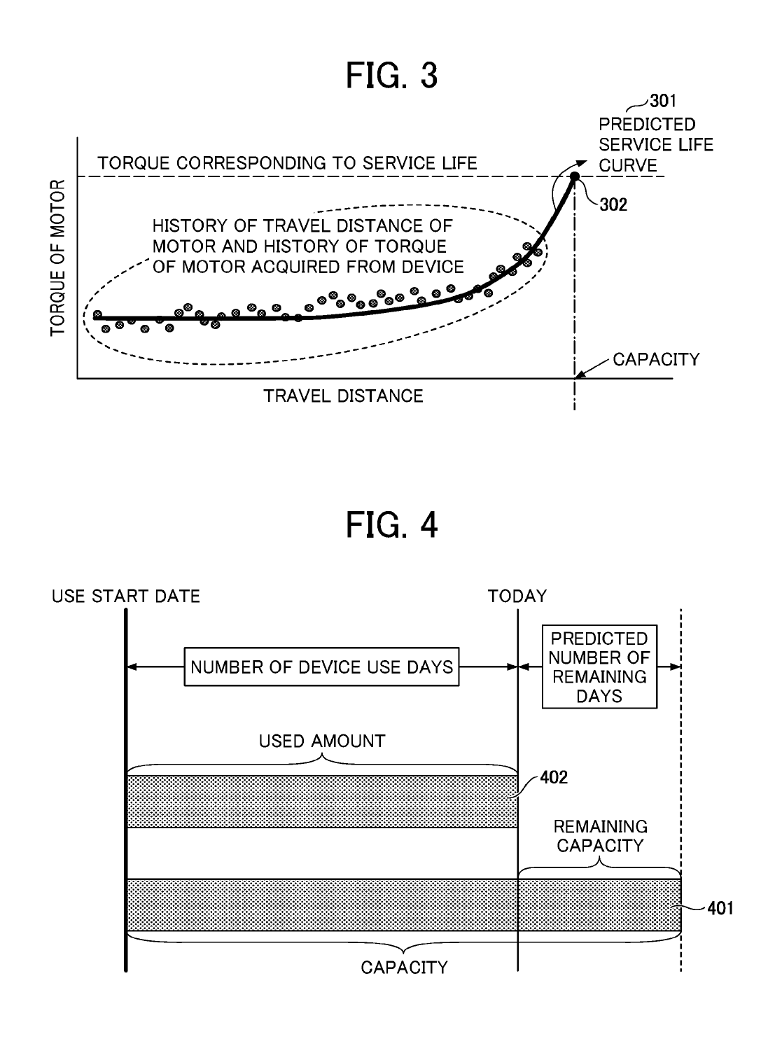

Next, an example operation of predicting a capacity from the use history of each of the devices 110_1 to 110_n will be described. Here, the capacity indicates the amount of consumables (or components to be replaced) that can be used from the use start date until the timing for refilling consumables (or timing for replacing components). FIG. 3 illustrates an example operation of predicting the capacity from the use history of a device. Specifically, FIG. 3 is an illustration for explaining an example operation for predicting the capacity from the use history of a motor, which is a component of the device 110_1 and is to be replaced.

In FIG. 3, the horizontal axis and the vertical axis represent the use history of the motor from the use start date of the device 110_1 (the horizontal axis represents a history of a used amount (travel distance) of the component to be replaced, and the vertical axis represents a history of a measured value (torque) of the component to be replaced). As illustrated in FIG. 3, during a certain period from the use start date, the torque of the motor is almost constant even if the travel distance of the motor is increased. On the other hand, after the certain period has elapsed from the use start date, the torque of the motor is increased depending on the travel distance of the motor.

When the torque of the motor reaches a certain value (the torque corresponding to the service life of the motor), the motor is likely to break down. Thus, if it is possible to predict the travel distance of the motor corresponding to the time point at which the torque of the motor reaches the certain value, it is also possible to predict the capacity of the motor.

FIG. 3 illustrates the prediction of the capacity of the motor. As illustrated in FIG. 3, from a relationship between the history of the travel distance of the motor and the history of the torque of the motor, an approximation curve (a predicted service life curve 301) is first obtained. Subsequently, an intersection point 302 of the predicted service life curve 301 and the certain value (the torque corresponding to the service life of the motor) is calculated. Thus, the capacity (travel distance) can be predicted.

### Operation for Calculating Predicted Number of Remaining Days

Next, an example operation for calculating the predicted number of remaining days from the capacity predicted by the above-descried prediction method will be described. FIG. 4 illustrates an example operation for calculating the predicted number of remaining days.

In FIG. 4, a graph 401 indicates the capacity of the motor. In addition, a graph 402 indicates a used amount of the motor from the use start date of the device 110_1 to the present (today).

As is clear from FIG. 4, a difference between the graph 401 and the graph 402 indicates a remaining travel distance for which the motor can be used (remaining capacity) from the present (today). In this embodiment, the number of days until the end of the remaining capacity (predicted number of remaining days) can be calculated from the average use history per unit period so far (e.g., average used amount of a day (use ratio)).

Specifically, first, the used amount of the motor is divided by the number of days (number of device use days) from the use start date of the device 110_1 to the present (today), and thereby the average used amount of a day (use ratio) can be obtained. Then, the remaining capacity is divided by the average used amount of a day (use ratio), and thereby the predicted number of remaining days can be calculated.

Specific Example in which Predicted Number of Remaining Days Varies

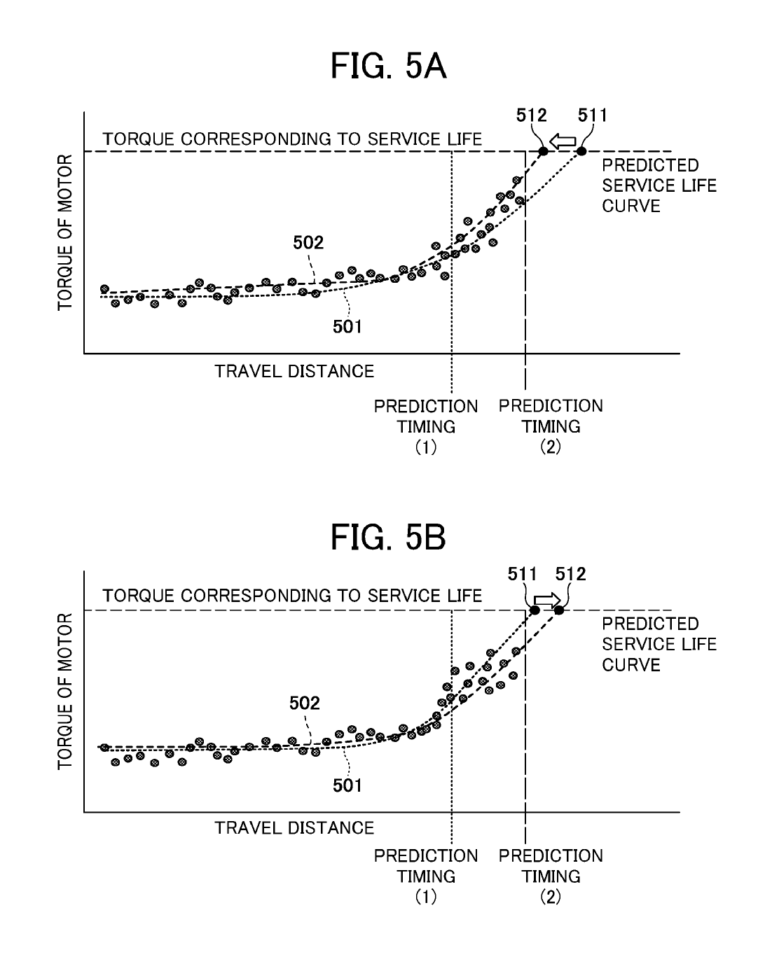

Next, a specific example in which the predicted number of remaining days calculated by the above-described calculation method varies will be described. FIGS. 5A and 5B illustrate examples in which the predicted number of remaining days varies. FIG. 5A illustrates an example in which the predicted number of remaining days decreases.

As illustrated in FIG. 5A, while an increase curve of a predicted service life curve 501 obtained when the predicted number of remaining days is calculated at prediction timing (1) is gentle, an increase curve of a predicted service life curve 502 obtained when the predicted number of remaining days is calculated at prediction timing (2) is sharp.

Thus, compared with an intersection point 511 of the predicted service life curve 501 and a certain value (torque corresponding to the service life of the motor), an intersection point 512 of the predicted service life curve 502 and the certain value (torque corresponding to the service life of the motor) shifts to the left. That is, compared with the predicted number of remaining days calculated at prediction timing (1), the predicted number of remaining days calculated at prediction timing (2) decreases.

In contrast, FIG. 5B illustrates an example in which the predicted number of remaining days increases. As illustrated in FIG. 5B, while the increase curve of the predicted service life curve 501 obtained when the predicted number of remaining days is calculated at prediction timing (1) is sharp, the increase curve of the predicted service life curve 502 obtained when the predicted number of remaining days is calculated at prediction timing (2) is gentle.

Thus, compared with the intersection point 511 of the predicted service life curve 501 and the certain value (torque corresponding to the service life of the motor), the intersection point 512 of the predicted service life curve 502 and the certain value (torque corresponding to the service life of the motor) shifts to the right. That is, compared with the predicted number of remaining days calculated at prediction timing (1), the predicted number of remaining days calculated at prediction timing (2) increases.

In the above manner, the predicted number of remaining days varies in accordance with a change of the predicted service life curve. In addition, since the predicted service life curve changes depending on variations of history information, the predicted service life curve changes depending on the prediction timing. That is, the predicted number of remaining days varies in accordance with the prediction timing.

In this embodiment, it is assumed that the predicted service life curve does not change and that the capacity is constant in order to simplify the following description. However, the used amount varies in the history information, which results in a change of the use ratio and variations of the predicted number of remaining days in accordance with the prediction timing.

### Functional Configuration of Management Apparatus

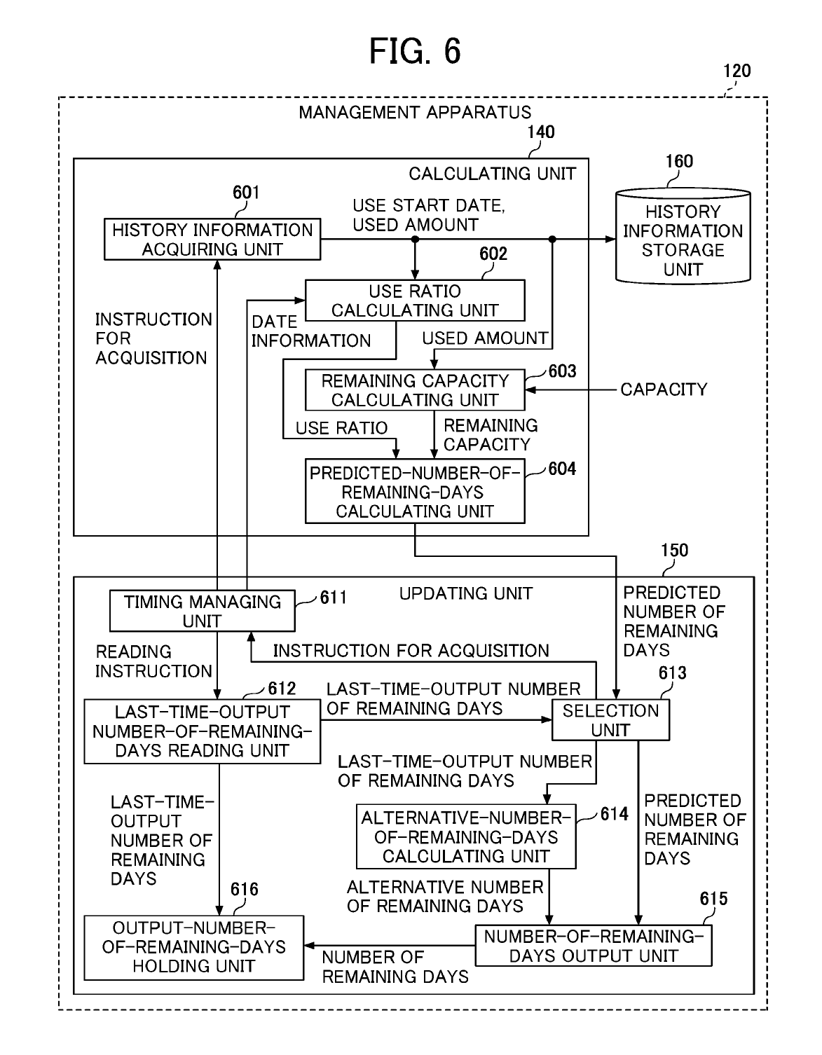

Next, a functional configuration (the calculating unit 140 and the updating unit 150) of the management apparatus 120 will be described in detail. FIG. 6 illustrates the functional configuration of the management apparatus 120 in detail.

As illustrated in FIG. 6, the calculating unit 140 includes a history information acquiring unit 601, a use ratio calculating unit 602, a remaining capacity calculating unit 603, and a predicted-number-of-remaining-days calculating unit 604.

The history information acquiring unit 601 is an example of acquisition means. Upon reception of an instruction for acquisition from a timing managing unit 611, the history information acquiring unit 601 acquires the history information as of the present from the devices 110_1 to 110_n. In this embodiment, the history information as of the present is acquired from the device 110_1 to simplify the following description.

Upon acquisition of the history information, the history information acquiring unit 601 stores, in the history information storage unit 160, the use start date and the used amount included in the history information and sends the use start date and the used amount to the use ratio calculating unit 602. As described above, since the capacity is constant (a case in which the used amount varies, which result in a change of the use ratio and variations of the predicted number of remaining days is described herein), the history information acquiring unit 601 acquires the use start date and the used amount as the history information.

Upon acquisition of the use start date and the used amount from the history information acquiring unit 601, the use ratio calculating unit 602 acquires date information indicating the present date (today) from the timing managing unit 611. Subsequently, the use ratio calculating unit 602 calculates the number of device use days and the average used amount of a day (use ratio) according to the following expressions (Expression 1 and Expression 2).

number of device use days=(date information)−(use start date) (Expression 1)

average used amount of a day (use ratio)=(used amount)/(number of device use days) (Expression 2)

The use ratio calculating unit 602 sends the calculated use ratio to the predicted-number-of-remaining-days calculating unit 604.

The remaining capacity calculating unit 603 acquires in advance the capacity of consumables and components to be replaced, and reads the used amount up to the present (today) from the history information storage unit 160, so as to calculate the remaining capacity according to the following expression (Expression 3).

remaining capacity=(capacity)−(used amount) (Expression 3)

The remaining capacity calculating unit 603 sends the calculated remaining capacity to the predicted-number-of-remaining-days calculating unit 604.

The predicted-number-of-remaining-days calculating unit 604 is an example of calculation means. The predicted-number-of-remaining-days calculating unit 604 calculates the predicted number of remaining days according to the following expression (Expression 4) by using the use ratio acquired from the use ratio calculating unit 602 and the remaining capacity acquired from the remaining capacity calculating unit 603.

predicted number of remaining days=(remaining capacity)/(use ratio) (Expression 4)

The predicted-number-of-remaining-days calculating unit 604 sends the calculated predicted number of remaining days to a selection unit 613.

The updating unit 150 includes the timing managing unit 611, a last-time-output number-of-remaining-days reading unit 612, the selection unit 613, an alternative-number-of-remaining-days calculating unit 614, a number-of-remaining-days output unit 615, and an output-number-of-remaining-days holding unit 616.

The timing managing unit 611 monitors a lapse of a unit period (e.g., a day), determines that the time has reached processing timing each time the unit period has elapsed, and sends a reading instruction to the last-time-output number-of-remaining-days reading unit 612. If the instruction for acquisition is received from the selection unit 613 in response to sending of the reading instruction to the last-time-output number-of-remaining-days reading unit 612, the timing managing unit 611 sends the instruction for acquisition to the history information acquiring unit 601. Furthermore, upon sending of the instruction for acquisition to the history information acquiring unit 601, the timing managing unit 611 sends the date information to the use ratio calculating unit 602.

Upon reception of the reading instruction from the timing managing unit 611, the last-time-output number-of-remaining-days reading unit 612 reads a last-time-output number of remaining days (e.g., the number of remaining days that was output a day ago) that is held in the output-number-of-remaining-days holding unit 616, and sends the last-time-output number of remaining days to the selection unit 613.

Upon acquisition of the last-time-output number of remaining days from the last-time-output number-of-remaining-days reading unit 612, the selection unit 613 determines whether the acquired last-time-output number of remaining days is greater than a predetermined threshold of the number of remaining days. If it is determined that the last-time-output number of remaining days is greater than the predetermined threshold of the number of remaining days, the selection unit 613 sends the instruction for acquisition to the timing managing unit 611. In addition, if the predicted number of remaining days is acquired from the predicted-number-of-remaining-days calculating unit 604 in response to sending of the instruction for acquisition to the timing managing unit 611, the selection unit 613 sends the acquired predicted number of remaining days to the number-of-remaining-days output unit 615.

On the other hand, if it is determined that the last-time-output number of remaining days is less than or equal to the predetermined threshold of the number of remaining days, the selection unit 613 sends, to the alternative-number-of-remaining-days calculating unit 614, the last-time-output number of remaining days sent from the last-time-output number-of-remaining-days reading unit 612.

Upon acquisition of the last-time-output number of remaining days from the selection unit 613, the alternative-number-of-remaining-days calculating unit 614 calculates the alternative number of remaining days by using the acquired last-time-output number of remaining days according to the following expression (Expression 5).

alternative number of remaining days=(last-time-output number of remaining days)−1 (Expression 5)

The alternative-number-of-remaining-days calculating unit 614 sends the calculated alternative number of remaining days to the number-of-remaining-days output unit 615.

The number-of-remaining-days output unit 615 is an example of output means. If the predicted number of remaining days is sent from the selection unit 613, the number-of-remaining-days output unit 615 outputs the predicted number of remaining days as the number of remaining days. Alternatively, if the alternative number of remaining days is sent from the alternative-number-of-remaining-days calculating unit 614, the number-of-remaining-days output unit 615 outputs the alternative number of remaining days as the number of remaining days.

Furthermore, the number-of-remaining-days output unit 615 updates the number of remaining days (the number of remaining days that was output a day ago and is held) held in the output-number-of-remaining-days holding unit 616 to the output number of remaining days, and transmits the output number of remaining days to the device 110_1.

Upon reception of a reading instruction from the last-time-output number-of-remaining-days reading unit 612, the output-number-of-remaining-days holding unit 616 sends, to the last-time-output number-of-remaining-days reading unit 612, the last-time-output number of remaining days that is currently held. In addition, upon reception of the number of remaining days from the number-of-remaining-days output unit 615, the output-number-of-remaining-days holding unit 616 updates the number of remaining days that is currently held to the received number of remaining days.

### 7. Flow of Process for Outputting Number of Remaining Days

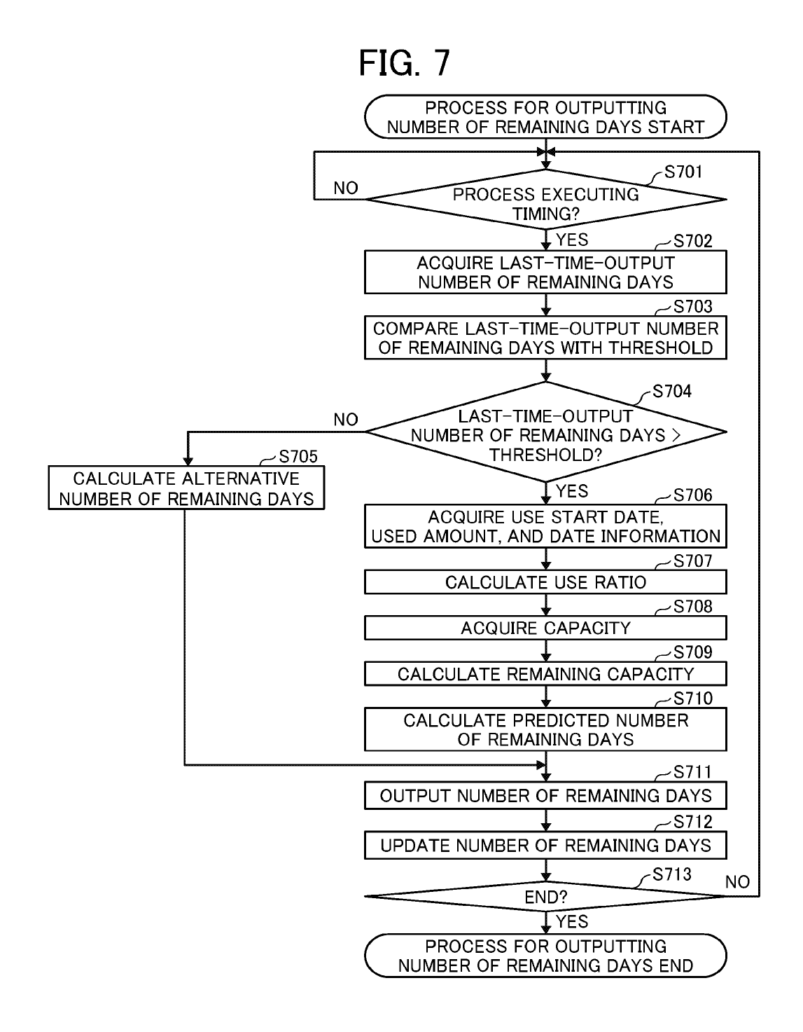

Next, flow of a process in which the management apparatus 120 outputs the number of remaining days will be described. FIG. 7 is a flowchart illustrating the flow of a process in which the management apparatus 120 according to the first embodiment outputs the number of remaining days.

In step S701, the timing managing unit 611 determines whether a unit period has elapsed from a last-time process and whether the time has reached process executing timing. If it is determined in step S701 that the time has not reached the process executing timing (NO in step S701), the process waits for the determination that the time has reached the process executing timing.

On the other hand, if it is determined in step S701 that the time has reached the process executing timing (YES in step S701), the timing managing unit 611 sends a reading instruction to the last-time-output number-of-remaining-days reading unit 612, and the process proceeds to step S702.

In step S702, the last-time-output number-of-remaining-days reading unit 612 acquires a last-time-output number of remaining days from the output-number-of-remaining-days holding unit 616.

In step S703, the selection unit 613 compares the last-time-output number of remaining days with a predetermined threshold of the number of remaining days. If it is determined in step S704 that the last-time-output number of remaining days is greater than the predetermined threshold of the number of remaining days (YES in step S704) as a result of comparison, the selection unit 613 sends an instruction for acquisition to the timing managing unit 611, and the process proceeds to step S706.

In response to sending of the instruction for acquisition from the timing managing unit 611 to the history information acquiring unit 601, in step S706, the history information acquiring unit 601 acquires a use start date and a used amount. In addition, the timing managing unit 611 sends date information to the use ratio calculating unit 602, and the use ratio calculating unit 602 acquires the date information.

In step S707, the use ratio calculating unit 602 calculates a use ratio by using the use start date, the used amount, and the date information.

In step S708, the remaining capacity calculating unit 603 acquires the used amount and the capacity. In step S709, the remaining capacity calculating unit 603 calculates a remaining capacity by using the used amount and the capacity.

In step S710, the predicted-number-of-remaining-days calculating unit 604 calculates a predicted number of remaining days by using the remaining capacity and the use ratio, and the selection unit 613 sends the calculated predicted number of remaining days to the number-of-remaining-days output unit 615.

On the other hand, if it is determined in step S704 that the last-time-output number of remaining days is less than or equal to the predetermined threshold of the number of remaining days (NO in step S704), the process proceeds to step S705.

In step S705, the alternative-number-of-remaining-days calculating unit 614 calculates an alternative number of remaining days on the basis of the last-time-output number of remaining days and sends the alternative number of remaining days to the number-of-remaining-days output unit 615.

In step S711, the number-of-remaining-days output unit 615 outputs the number of remaining days. Note that if the predicted number of remaining days is sent from the selection unit 613, the number-of-remaining-days output unit 615 outputs the sent predicted number of remaining days as the number of remaining days, and if the alternative number of remaining days is sent from the alternative-number-of-remaining-days calculating unit 614, the number-of-remaining-days output unit 615 outputs the sent alternative number of remaining days as the number of remaining days.

In step S712, the number-of-remaining-days output unit 615 updates the number of remaining days that is held in the output-number-of-remaining-days holding unit 616 (the last-time-output number of remaining days) to the output number of remaining days.

In step S713, the timing managing unit 611 determines whether the process for outputting the number of remaining days is to end. If it is determined in step S713 that the process for outputting the number of remaining days is to continue (NO in step S713), the process returns to step S701.

On the other hand, if it is determined in step S713 that the process for outputting the number of remaining days is to end (YES in step S713), the process for outputting the number of remaining days ends.

### 8. Specific Example of Process for Outputting Number of Remaining Days

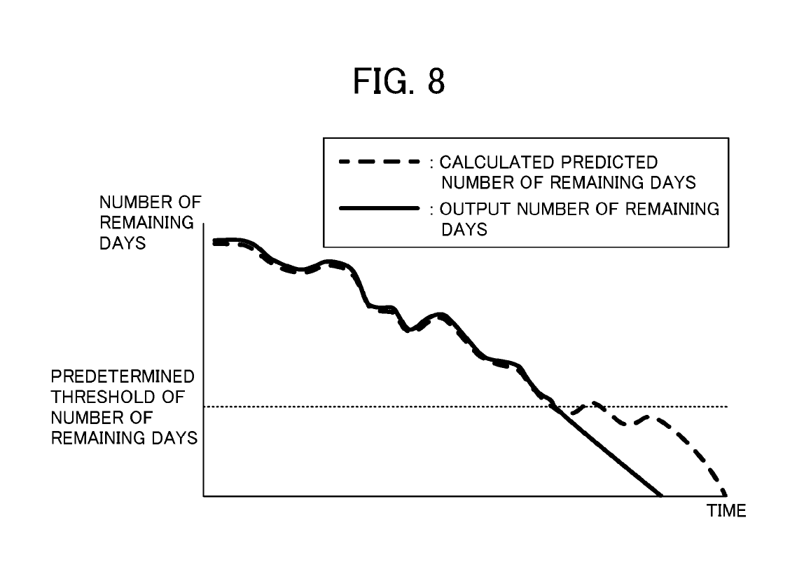

Next, a specific example of the process for outputting the number of remaining days will be described. FIG. 8 illustrates the specific example of the process for outputting the number of remaining days. In FIG. 8, the horizontal axis represents time elapsed from the use start date, and the vertical axis represents the predicted number of remaining days calculated by the predicted-number-of-remaining-days calculating unit 604 or the number of remaining days output from the number-of-remaining-days output unit 615.

As illustrated in FIG. 8, if the calculated predicted number of remaining days is greater than the predetermined threshold of the number of remaining days, the predicted number of remaining days is output as the number of remaining days, and thus, the predicted number of remaining days is equal to the number of remaining days that is output.

On the other hand, if the calculated predicted number of remaining days is less than or equal to the predetermined threshold of the number of remaining days, the alternative number of remaining days is output as the number of remaining days, and thus, the number of remaining days is decreased by a unit period each time the unit period passes (e.g., the number of remaining days is decreased one by one for each day). Accordingly, while the calculated predicted number of remaining days when and after becoming less than or equal to the predetermined threshold of the number of remaining days is increased or decreased, the number of remaining days that is output is monotonically decreased.

If the number of remaining days that it output is not increased or decreased but is monotonically decreased in the above manner, the operator can reliably perform operation of the corresponding device at appropriate operation timing. As a result, the management apparatus 120 can increase the operation efficiency of the operator who performs operations of devices, although the related art has forced the operator to do inefficient operation, such as refiling consumables after running out or replacing components after breakdown.

As is clear from the above description, the management apparatus 120 according to the first embodiment
calculates the predicted number of remaining days indicating timing for refilling consumables or timing for replacing components of a device by using the use history, the date information of the present (today), and the capacity, and
if the last-time-output number of remaining days is greater than the predetermined threshold of the number of remaining days, outputs the predicted number of remaining days calculated this time as the number of remaining days, and if the last-time-output number of remaining days is less than or equal to the predetermined threshold of the number of remaining days, calculates the alternative number of remaining days, which is monotonically decreased, and outputs the calculated alternative number of remaining days as the number of remaining days.

Accordingly, in the management apparatus 120 according to the first embodiment, when and after the last-time-output number of remaining days becomes less than or equal to the predetermined threshold of the number of remaining days, the output number of remaining days is not increased or decreased but is monotonically decreased. As a result, with the management apparatus 120 according to the first embodiment, the operator can reliably perform operation of the corresponding device at appropriate operation timing in accordance with an increase or a decrease of the output number of remaining days, thereby increasing the operation efficiency of the operator.

### Second Embodiment

In the first embodiment described above, the alternative number of remaining days is output as the number of remaining days once the last-time-output number of remaining days becomes less than or equal to the predetermined threshold of the number of remaining days.

However, under a condition in which the predicted number of remaining days suddenly changes before or after the predetermined threshold of the number of remaining days, it is not appropriate to output the alternative number of remaining days (=last-time-output number of remaining days−1) as the number of remaining days.

Accordingly, in a second embodiment, under a condition in which the predicted number of remaining days suddenly changes before or after the predetermined threshold of the number of remaining days, the selection unit 613 replaces the calculated predicted number of remaining days with the predetermined threshold of the number of remaining days. Thus, the number-of-remaining-days output unit 615 can output the number of remaining days that corresponds with the sudden change of the predicted number of remaining days before or after the predetermined threshold of the number of remaining days. Now, the second embodiment will be described mainly on differences from the above-described first embodiment.

### Flow of Process for Outputting Number of Remaining Days

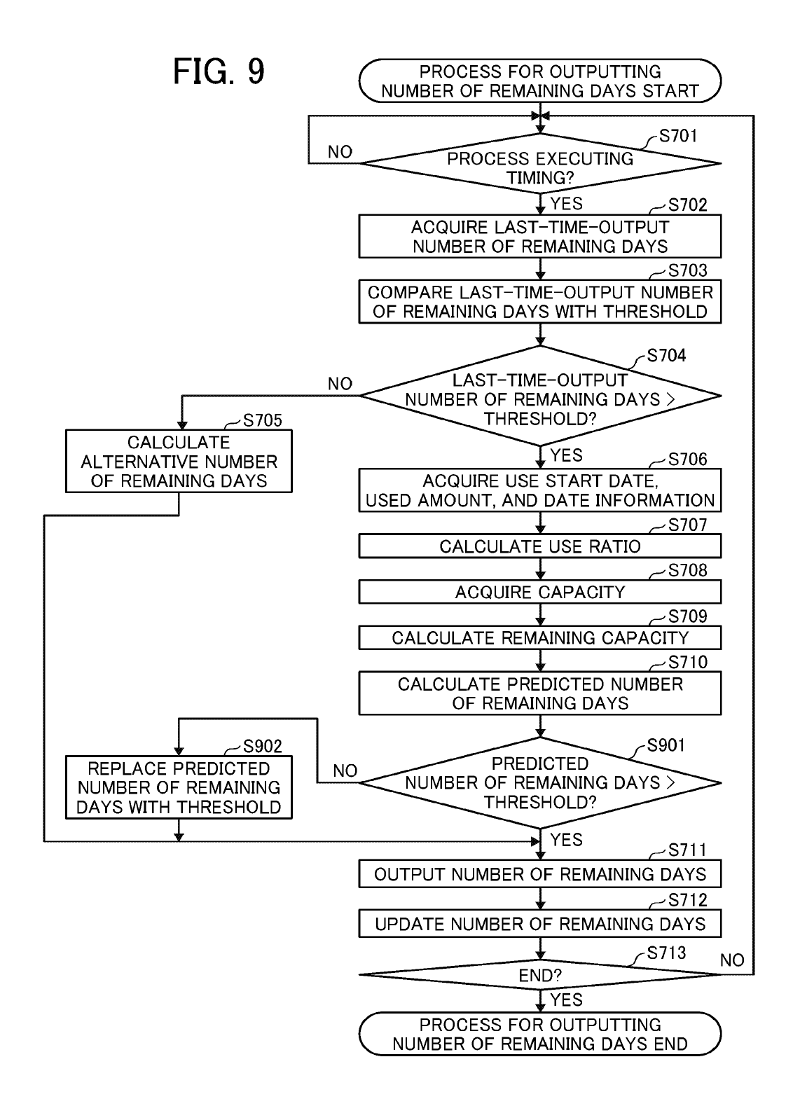

FIG. 9 is a flowchart illustrating flow of a process in which the management apparatus 120 according to the second embodiment outputs the number of remaining days. Differences from the process for outputting the number of remaining days described with reference to FIG. 7 are step S901 and step S902.

In step S901, the selection unit 613 determines whether the predicted number of remaining days that is sent from the predicted-number-of-remaining-days calculating unit 604 is greater than or equal to the predetermined threshold of the number of remaining days. If it is determined in step S901 that the sent predicted number of remaining days is greater than the predetermined threshold of the number of remaining days (YES in step S901), the predicted number of remaining days is sent to the number-of-remaining-days output unit 615, and the process proceeds to step S711.

On the other hand, if it is determined in step S901 that the sent predicted number of remaining days is less than or equal to the predetermined threshold of the number of remaining days (NO in step S901), the process proceeds to step S902.

In step S902, the selection unit 613 replaces the predicted number of remaining days with the predetermined threshold of the number of remaining days, and then sends the predetermined threshold of the number of remaining days to the number-of-remaining-days output unit 615. Thus, the number-of-remaining-days output unit 615 outputs the predetermined threshold of the number of remaining days as the number of remaining days.

As is clear from the above description, the management apparatus 120 according to the second embodiment
calculates the predicted number of remaining days indicating timing for refilling consumables or timing for replacing components of a device by using the use history, the date information of the present (today), and the capacity,
if the last-time-output number of remaining days is greater than the predetermined threshold of the number of remaining days and the predicted number of remaining days calculated this time is less than or equal to the predetermined threshold of the number of remaining days, outputs the predetermined threshold of the number of remaining days as the number of remaining days, and if the last-time-output number of remaining days is greater than the predetermined threshold of the number of remaining days and the predicted number of remaining days calculated this time is greater than the predetermined threshold of the number of remaining days, outputs the calculated predicted number of remaining days as the number of remaining days, and
if the last-time-output number of remaining days is less than the predetermined threshold of the number of remaining days, calculates the alternative number of remaining days, which is monotonically decreased, and outputs the calculated alternative number of remaining days as the number of remaining days.

Accordingly, the management apparatus 120 according to the second embodiment can produce, in addition to the same effects as those of the above-described first embodiment, an effect of making it possible to output the number of remaining days that corresponds with the sudden change of the predicted number of remaining days before or after the predetermined threshold of the number of remaining days.

### Third Embodiment

In the first and second embodiments described above, the number of device use days is calculated by using the date information and the use start date. However, even after the use start date of a device, actually, the device may be barely used in some days, and it is not appropriate to include such days in the device use days.

Accordingly, in a third embodiment, it is determined whether the device is actually used. If it is determined that the device is used, this day is included in the device use days. Now, the third embodiment will be described mainly on differences from the above-described first embodiment.

### Flow of Process for Outputting Number of Remaining Days

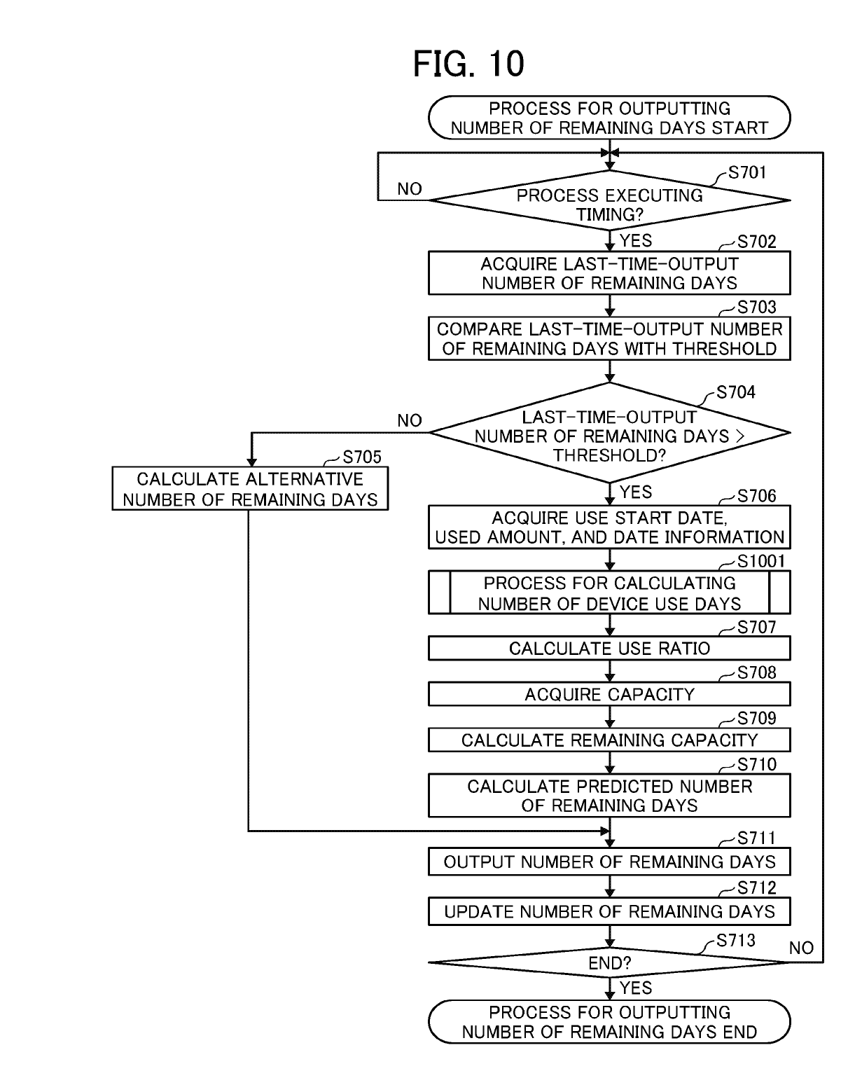

FIG. 10 is a flowchart illustrating flow of a process in which the management apparatus 120 according to the third embodiment outputs the number of remaining days. A difference from the process for outputting the number of remaining days described with reference to FIG. 7 is step S1001.

In step S1001, the use ratio calculating unit 602 performs a process for calculating the number of device use days and calculates the number of days in which the device was actually used up to the present on the basis of a history of a previous used amount stored in the history information storage unit 160.

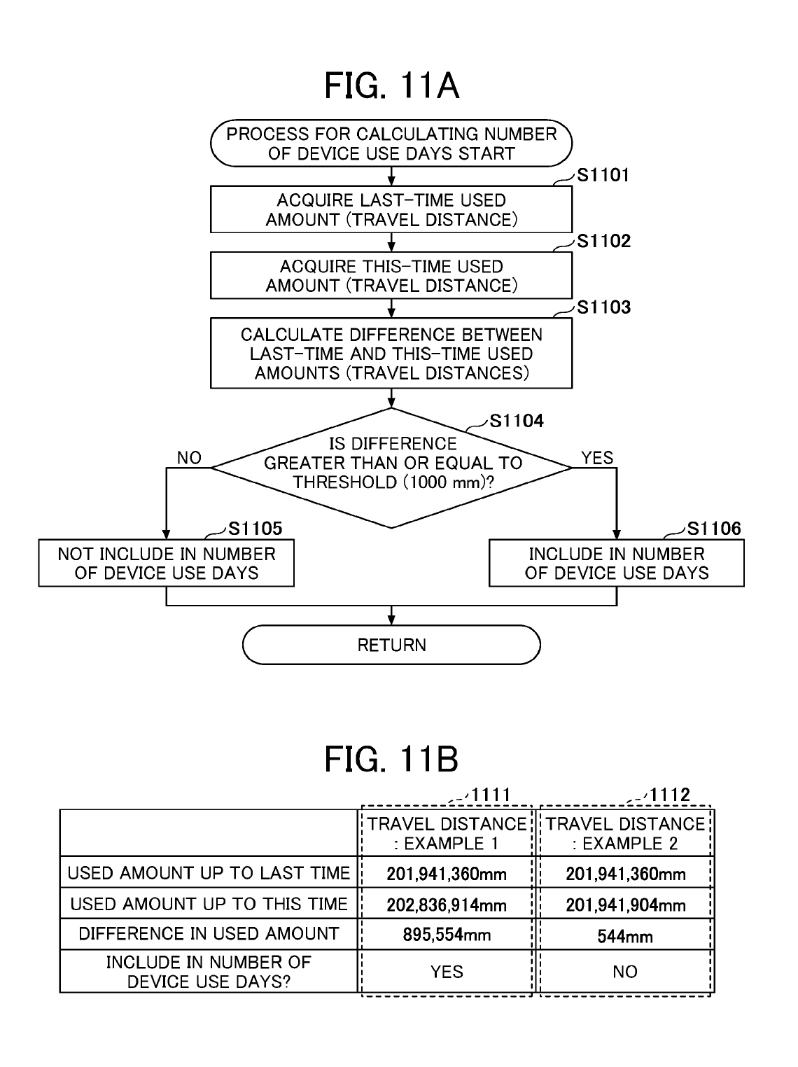

FIG. 11A is a flowchart illustrating flow of the process for calculating the number of device use days. As illustrated in FIG. 11A, in step S1101, the use ratio calculating unit 602 reads the previous used amount stored in the history information storage unit 160, thereby acquiring a last-time used amount (e.g., travel distance).

In step S1102, the use ratio calculating unit 602 acquires a this-time used amount corresponding to the last-time used amount acquired in step S1101 (see FIG. 11B).

In step S1103, the use ratio calculating unit 602 calculates a difference between the last-time used amount acquired in step S1101 and the this-time used amount acquired in step S1102.

In step S1104, the use ratio calculating unit 602 determines whether the calculated difference is greater than or equal to a predetermined threshold. If it is determined in step S1104 that the calculated difference is not greater than or equal to the predetermined threshold (NO in step S1104), the process proceeds to step S1105.

In step S1105, the use ratio calculating unit 602 does not include, in the number of device use days, the number of days from the day for which the last-time used amount is acquired to the day for which the this-time used amount is acquired (see reference numeral 1112 in FIG. 11B).

On the other hand, if it is determined in step S1104 that the calculated difference is greater than or equal to the predetermined threshold (YES in step S1104), the process proceeds to step S1106.

In step S1106, the use ratio calculating unit 602 includes, in the number of device use days, the number of days from the day for which the last-time used amount is acquired to the day for which the this-time used amount is acquired (see reference numeral 1111 in FIG. 11B).

This process for calculating the number of device use days is performed for all of used amounts from the use start date of the device to the present, and thereby the actual number of device use days can be calculated.

As is clear from the above description, the management apparatus 120 according to the third embodiment
determines whether the difference between the last-time used amount and the this-time used amount is greater than or equal to a predetermined threshold, and in accordance with the result, includes or does not include the number of days in the number of device use days to calculate the actual number of device use days, and
calculates the use ratio by using the actual number of device use days.

Accordingly, the management apparatus 120 according to the third embodiment can produce, in addition to the same effects as those of the above-described first embodiment, an effect of making it possible to calculate the predicted number of remaining days by using a more accurate use ratio.

### Fourth Embodiment

In the first embodiment described above, if it is determined that the last-time-output number of remaining days is less than or equal to the predetermined threshold of the number of remaining days, the alternative number of remaining days (=last-time-output number of remaining days−1) is output as the number of remaining days. However, even when and after the last-time-output number of remaining days becomes less than or equal to the predetermined threshold of the number of remaining days, in a case where a decrease amount of the predicted number of remaining days is large, it is desirable to output the predicted number of remaining days as the number of remaining days.

Thus, it is possible to reliably reflect a change with a large decrease amount on the number of remaining days to be output. Now, a fourth embodiment will be described mainly on differences from the above-described first embodiment.

### Flow of Process for Outputting Number of Remaining Days

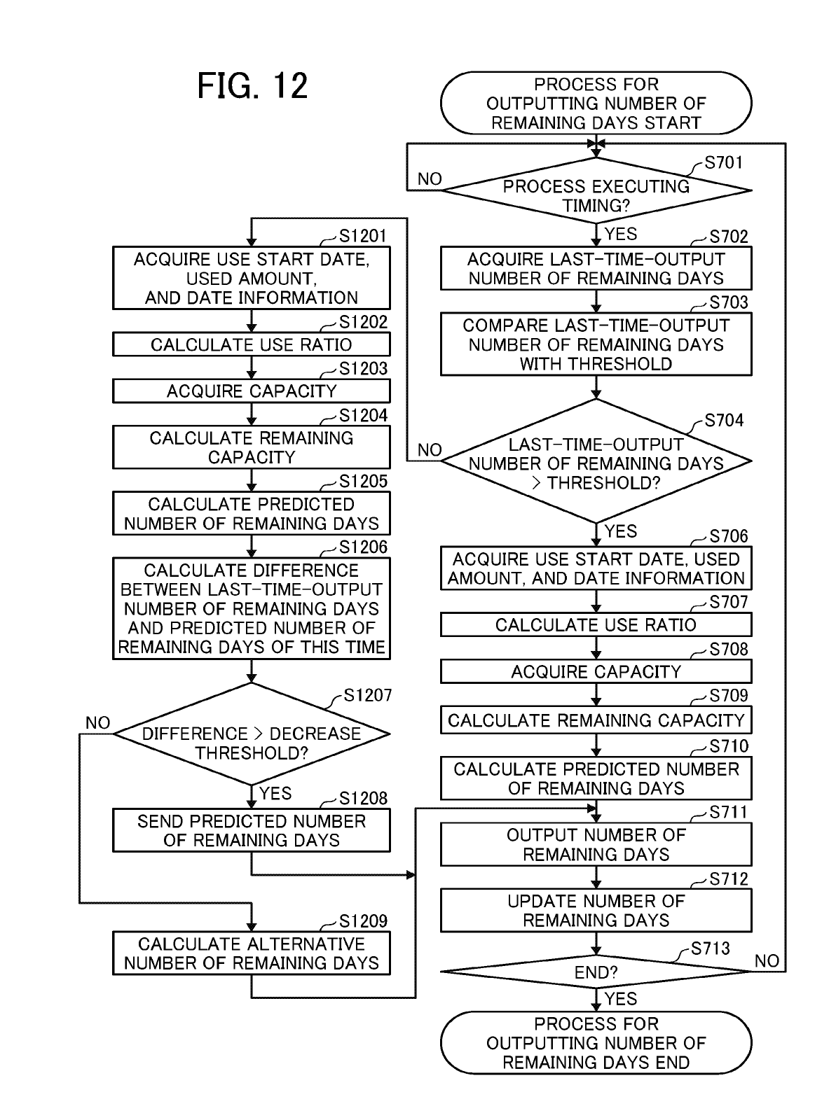

FIG. 12 is a flowchart illustrating flow of a process in which the management apparatus 120 according to the fourth embodiment outputs the number of remaining days. Differences from the process for outputting the number of remaining days described with reference to FIG. 7 are steps S1201 to S1209.

In step S1201, the timing managing unit 611 sends an instruction for acquisition to the history information acquiring unit 601, and the history information acquiring unit 601 acquires the use start date and the used amount. In addition, the timing managing unit 611 sends the date information to the use ratio calculating unit 602, and the use ratio calculating unit 602 acquires the date information.

In step S1202, the use ratio calculating unit 602 calculates the use ratio by using the use start date, the used amount, and the date information.

In step S1203, the remaining capacity calculating unit 603 acquires the used amount and the capacity. In step S1204, the remaining capacity calculating unit 603 calculates the remaining capacity by using the used amount and the capacity.

In step S1205, the predicted-number-of-remaining-days calculating unit 604 calculates the predicted number of remaining days by using the use ratio and the remaining capacity.

In step S1206, the selection unit 613 calculates a difference between the last-time-output number of remaining days and the predicted number of remaining days calculated this time.

In step S1207, the selection unit 613 determines whether the calculated difference is greater than a predetermined decrease threshold. If it is determined in step S1207 that the calculated difference is greater than the predetermined decrease threshold (YES in step S1207), the process proceeds to step S1208.

In step S1208, the selection unit 613 sends the calculated predicted number of remaining days to the number-of-remaining-days output unit 615.

On the other hand, if it is determined in step S1207 that the calculated difference is less than or equal to the predetermined decrease threshold (NO in step S1207), the process proceeds to step S1209.

In step S1209, the alternative-number-of-remaining-days calculating unit 614 calculates the alternative number of remaining days on the basis of the last-time-output number of remaining days, and sends the alternative number of remaining days to the number-of-remaining-days output unit 615.

As is clear from the above description, the management apparatus 120 according to the fourth embodiment
calculates the predicted number of remaining days even when and after the last-time-output number of remaining days becomes less than or equal to the predetermined threshold of the number of remaining days, and, if the difference from the last-time-output number of remaining days is greater than the predetermined decrease threshold, outputs the predicted number of remaining days as the number of remaining days.

Accordingly, the management apparatus 120 according to the fourth embodiment can produce, in addition to the same effects as those of the above-described first embodiment, an effect of making it possible to reliably reflect a change with a large decrease amount of the predicted number of remaining days on the number of remaining days to be output.

### Fifth Embodiment

In the fourth embodiment described above, even when and after the last-time-output number of remaining days becomes less than or equal to the predetermined threshold of the number of remaining days, if the decrease amount of the predicted number of remaining days is large, the predicted number of remaining days is output as the number of remaining days. In contrast, in a fifth embodiment, when and after the last-time-output number of remaining days becomes less than or equal to the predetermined threshold of the number of remaining days, even if the decrease amount of the predicted number of remaining days is large, the alternative number of remaining days is output instead as the number of remaining days. In addition, in the fifth embodiment, a message is added so as to illustrate the large decrease amount of the predicted number of remaining days. Now, the fifth embodiment will be described mainly on a difference from the above-described fourth embodiment.

### Flow of Process for Outputting Number of Remaining Days

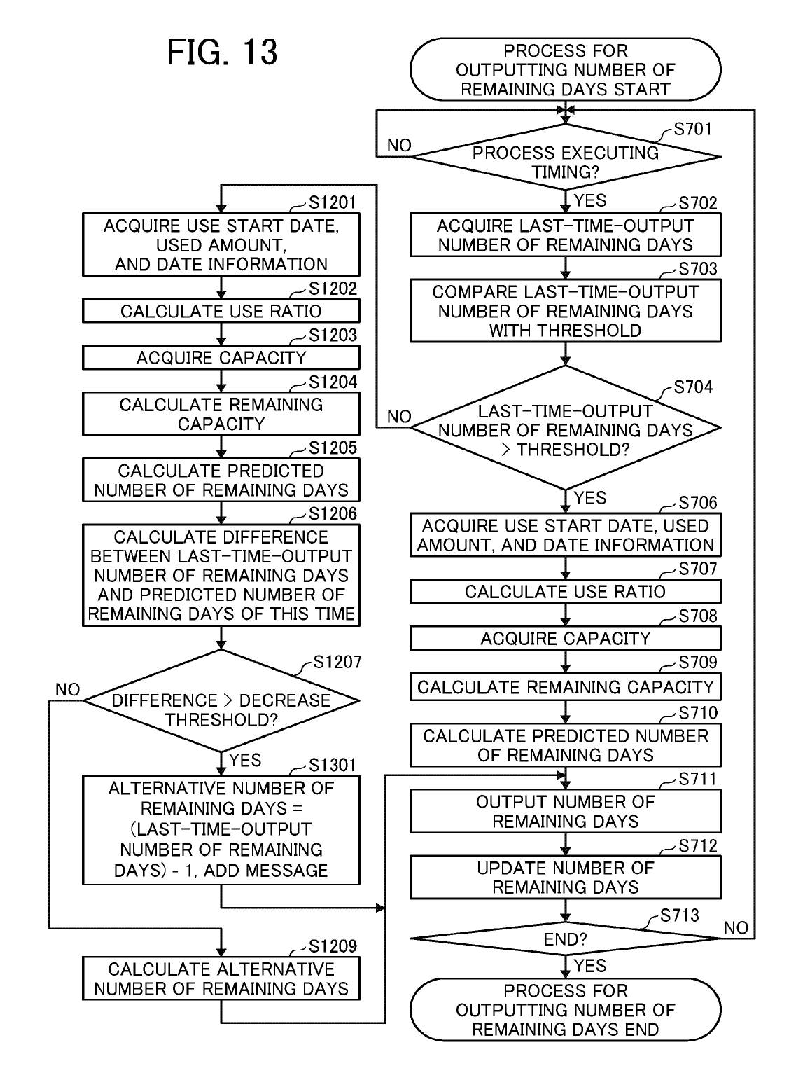

FIG. 13 is a flowchart illustrating flow of a process in which the management apparatus 120 according to the fifth embodiment outputs the number of remaining days. A difference from the process for outputting the number of remaining days described with reference to FIG. 12 is step S1301.

In step S1301, the alternative-number-of-remaining-days calculating unit 614 calculates the alternative number of remaining days based on the last-time-output number of remaining days. In addition, the alternative-number-of-remaining-days calculating unit 614 generates a message (e.g., “early replacement recommended”) and sends the message to the number-of-remaining-days output unit 615 together with the calculated alternative number of remaining days.

As is clear from the above description, the management apparatus 120 according to the fifth embodiment
calculates the predicted number of remaining days even when and after the last-time-output number of remaining days becomes less than or equal to the predetermined threshold of the number of remaining days so as to calculate the difference from the last-time-output number of remaining days, and, if the difference is greater than the predetermined decrease threshold, outputs the message together with the alternative number of remaining days.

Accordingly, the management apparatus 120 according to the fifth embodiment can produce, in addition to the same effects as those of the above-described first embodiment, an effect of making it possible to reliably illustrate a change with a large decrease amount of the predicted number of remaining days.

### Sixth Embodiment

In the first to fifth embodiments described above, it is determined whether the last-time-output number of remaining days is greater than the predetermined threshold of the number of remaining days, and in accordance with the result, the number of remaining days to be output is switched. In contrast, in a sixth embodiment, it is determined whether the last-time-output number of remaining days is greater than the calculated predicted number of remaining days, and in accordance with the result, the number of remaining days to be output is switched. Now, the sixth embodiment will be described mainly on differences from the above-described first embodiment.

### Flow of Process for Outputting Number of Remaining Days

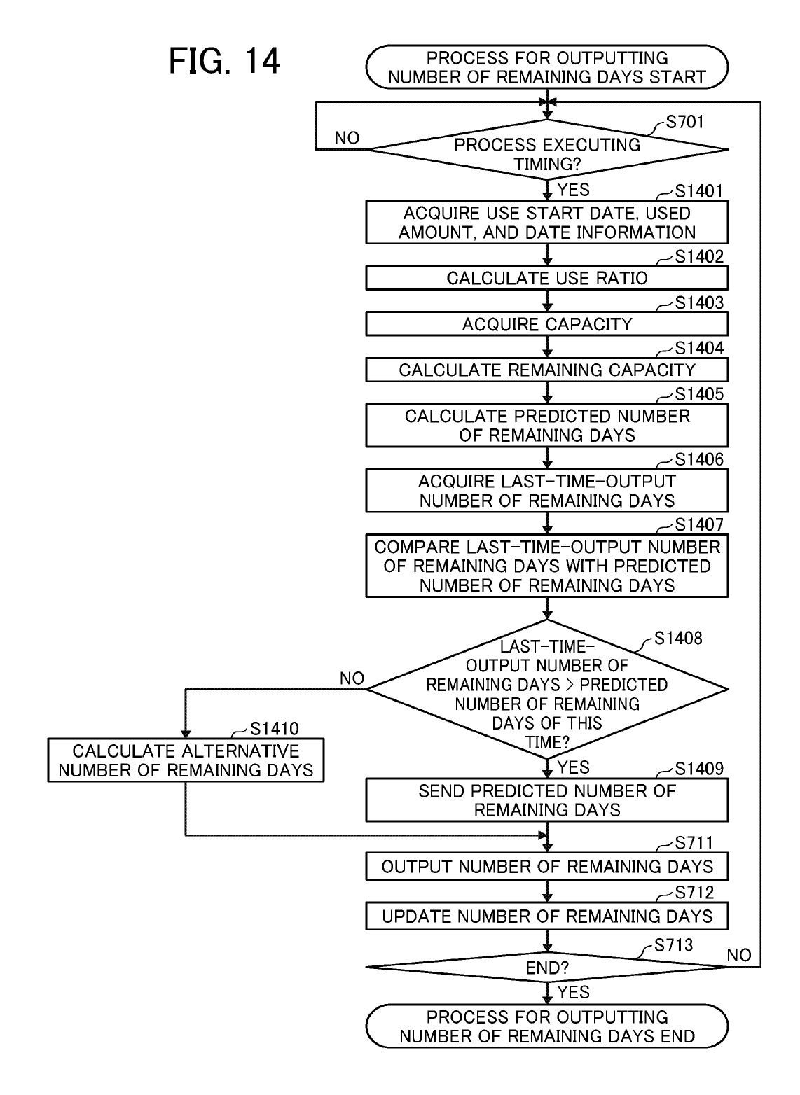

FIG. 14 is a flowchart illustrating flow of a process in which the management apparatus 120 according to the sixth embodiment outputs the number of remaining days. Differences from the process for outputting the number of remaining days described with reference to FIG. 7 are steps S1401 to S1410.

In step S1401, the timing managing unit 611 sends an instruction for acquisition to the history information acquiring unit 601, and the history information acquiring unit 601 acquires the use start date and the used amount. In addition, the timing managing unit 611 sends the date information to the use ratio calculating unit 602, and the use ratio calculating unit 602 acquires the date information.

In step S1402, the use ratio calculating unit 602 calculates the use ratio by using the use start date, the used amount, and the date information.

In step S1403, the remaining capacity calculating unit 603 acquires the used amount and the capacity. In step S1404, the remaining capacity calculating unit 603 calculates the remaining capacity by using the used amount and the capacity.

In step S1405, the predicted-number-of-remaining-days calculating unit 604 calculates the predicted number of remaining days by using the use ratio and the remaining capacity, and sends the predicted number of remaining days to the selection unit 613.

In step S1406, the selection unit 613 acquires the last-time-output number of remaining days. In step S1407, the selection unit 613 compares the calculated predicted number of remaining days and the acquired last-time-output number of remaining days with each other.

In step S1408, the selection unit 613 determines whether the last-time-output number of remaining days is greater than the predicted number of remaining days. If it is determined that the last-time-output number of remaining days is greater than the predicted number of remaining days (YES in step S1408), the process proceeds to step S1409.

In step S1409, the selection unit 613 sends the predicted number of remaining days to the number-of-remaining-days output unit 615.

On the other hand, if it is determined in step S1408 that the last-time-output number of remaining days is less than or equal to the predicted number of remaining days (NO in step S1408), the process proceeds to step S1410.

In step S1410, the selection unit 613 sends the last-time-output number of remaining days to the alternative-number-of-remaining-days calculating unit 614. In addition, the alternative-number-of-remaining-days calculating unit 614 calculates the alternative number of remaining days on the basis of the last-time-output number of remaining days and sends the alternative number of remaining days to the number-of-remaining-days output unit 615.

As is clear from the above description, the management apparatus 120 according to the sixth embodiment
determines whether the last-time-output number of remaining days is greater than the predicted number of remaining days calculated this time, and in accordance with the result, switches the number of remaining days to be output, and
if the last-time-output number of remaining days is greater than the predicted number of remaining days calculated this time, outputs the predicted number of remaining days as the number of remaining days, and if the last-time-output number of remaining days is less than or equal to the predicted number of remaining days calculated this time, outputs the alternative number of remaining days as the number of remaining days.

Accordingly, the management apparatus 120 according to the sixth embodiment can produce, in addition to the same effects as those of the above-described first embodiment, an effect of making it possible to monotonically decrease the number of remaining days to be output, even if the last-time-output number of remaining days is greater than the predetermined threshold of the number of remaining days.

### Seventh Embodiment

In the sixth embodiment described above, it is determined whether the last-time-output number of remaining days is greater than the calculated predicted number of remaining days, and in accordance with the result, the number of remaining days to be output is switched. In contrast, in a seventh embodiment, even if the last-time-output number of remaining days is less than or equal to the calculated predicted number of remaining days, if the last-time-output number of remaining days is greater than the predetermined threshold of the number of remaining days, the predicted number of remaining days is output as the number of remaining days. Now, the seventh embodiment will be described mainly on differences from the above-described sixth embodiment.

### Flow of Process for Outputting Number of Remaining Days

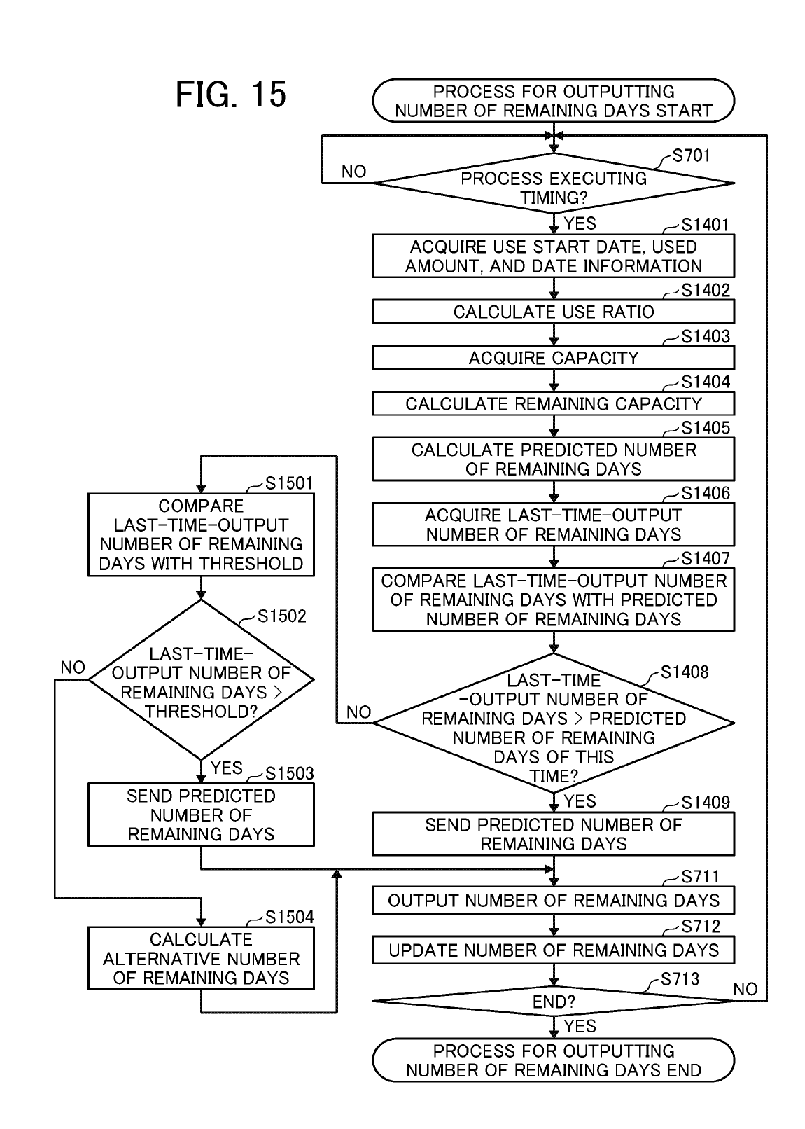

FIG. 15 is a flowchart illustrating flow of a process in which the management apparatus 120 according to the seventh embodiment outputs the number of remaining days. Differences from the process for outputting the number of remaining days described with reference to FIG. 14 are steps S1501 to S1504.

In step S1501, the selection unit 613 compares the last-time-output number of remaining days with the predetermined threshold of the number of remaining days. If the selection unit 613 determines in step S1502 that the last-time-output number of remaining days is greater than the predetermined threshold of the number of remaining days as a result of comparison (YES in step S1502), the process proceeds to step S1503.

In step S1503, the selection unit 613 sends the calculated predicted number of remaining days to the number-of-remaining-days output unit 615.

On the other hand, if it is determined in step S1502 that the last-time-output number of remaining days is less than or equal to the predetermined threshold of the number of remaining days (NO in step S1502), the process proceeds to step S1504.

In step S1504, the selection unit 613 sends the last-time-output number of remaining days to the alternative-number-of-remaining-days calculating unit 614. In addition, the alternative-number-of-remaining-days calculating unit 614 calculates the alternative number of remaining days on the basis of the sent last-time-output number of remaining days and sends the alternative number of remaining days to the number-of-remaining-days output unit 615.

As is clear from the above description, the management apparatus 120 according to the seventh embodiment
determines whether the last-time-output number of remaining days is greater than the predicted number of remaining days calculated this time, and in accordance with the result, switches the number of remaining days to be output,
if the last-time-output number of remaining days is greater than the predicted number of remaining days calculated this time, outputs the predicted number of remaining days as the number of remaining days,
even if, on the other hand, the last-time-output number of remaining days is less than or equal to the predicted number of remaining days calculated this time, if the last-time-output number of remaining days is greater than the predetermined threshold of the number of remaining days, outputs the predicted number of remaining days as the number of remaining days, and
if the last-time-output number of remaining days is less than or equal to the predicted number of remaining days calculated this time and is less than or equal to the predetermined threshold of the number of remaining days, outputs the alternative number of remaining days as the number of remaining days.

Thus, the management apparatus 120 according to the seventh embodiment can produce the same effects as those of the above-described first embodiment.

### Other Embodiments

In the first embodiment described above, the unit period is a day, and the alternative number of remaining days is calculated as (last-time-output number of remaining days)−1. However, the unit period may be any period other than the day. In addition, the alternative number of remaining days may be obtained by subtracting the unit period (constant) from the last-time-output number of remaining days. In any case, once the last-time-output number of remaining days becomes less than or equal to the predetermined threshold of the number of remaining days, an output value may be output such that the number of remaining days (the output value) that is output this time (for an N-th time) is less than or equal to the number of remaining days (less than or equal to the output value) that is output last time (for an (N−1)-th time).

In addition, in the above first to seventh embodiments, the functions of the calculating unit 140 and the updating unit 150 are implemented by the management apparatus 120. However, one or more of the functions of the calculating unit 140 and the updating unit 150 may be implemented by each of the devices 110_1 to 110_n.

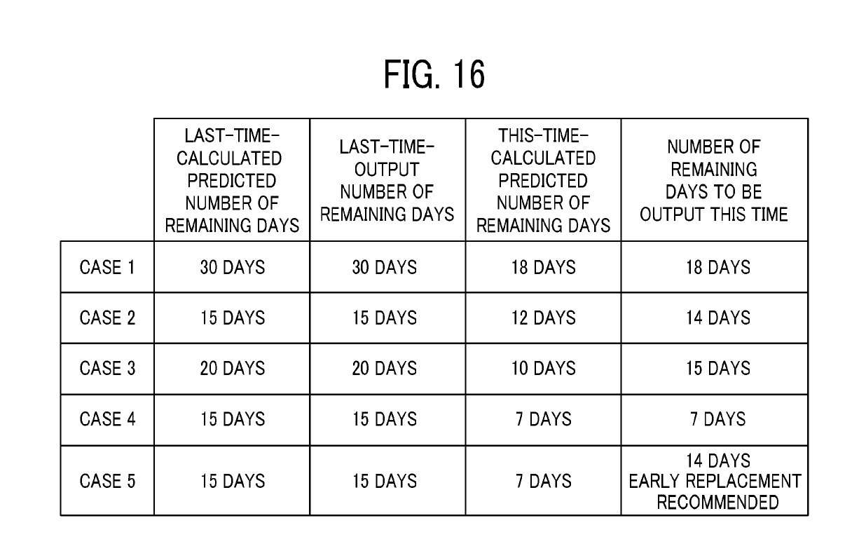

Furthermore, although the above first to seventh embodiments do not describe a specific output example of the management apparatus 120, for example, the management apparatus 120 may output the number of remaining days as illustrated in FIG. 16.

FIG. 16 illustrates examples in which the management apparatuses 120 according to the embodiments output the number of remaining days. FIG. 16 illustrates, as cases 1 to 5, examples in which the management apparatuses 120 according to the first, second, fourth, and fifth embodiments output the number of remaining days where the unit period is a day, the predetermined threshold of the number of remaining days is 15 days, and the decrease threshold is 5 days.

In FIG. 16, “case 1” illustrates a case where it is determined that the last-time-output number of remaining days is greater than the predetermined threshold of the number of remaining days in the above-described first embodiment (FIG. 7). As illustrated in FIG. 16, in “case 1”, the last-time-output number of remaining days is 30 days and is greater than the predetermined threshold of the number of remaining days, which is 15 days. Accordingly, the management apparatus 120 outputs the predicted number of remaining days of this time, which is 18 days, as the number of remaining days.

In addition, “case 2” illustrates a case where it is determined that the last-time-output number of remaining days is less than or equal to the predetermined threshold of the number of remaining days in the above-described first embodiment (FIG. 7). As illustrated in FIG. 16, in “case 2”, the last-time-output number of remaining days is 15 days and is equal to the predetermined threshold of the number of remaining days, which is 15 days. Accordingly, the management apparatus 120 outputs, not the calculated the predicted number of remaining days, which is 12 days, but the alternative number of remaining days, which is 14 days, as the number of remaining days. The alternative number of remaining days is obtained by (last-time-output number of remaining days)−1=15−1.

In addition, “case 3” illustrates a case where it is determined that the last-time-output number of remaining days is greater than the predetermined threshold of the number of remaining days and where it is determined that the calculated predicted number of remaining days is less than or equal to the predetermined threshold of the number of remaining days in the above-described second embodiment (FIG. 9). As illustrated in FIG. 16, in “case 3”, the last-time-output number of remaining days is 20 days and is greater than the predetermined threshold of the number of remaining days, which is 15 days. However, the predicted number of remaining days calculated this time is 10 days and is less than or equal to the predetermined threshold of the number of remaining days, which is 15 days. Accordingly, the management apparatus 120 outputs, not the calculated the predicted number of remaining days, which is 12 days, but the predetermined threshold of the number of remaining days, which is 15 days, as the number of remaining days.

In addition, “case 4” illustrates a case where it is determined that the last-time-output number of remaining days is less than or equal to the predetermined threshold of the number of remaining days and where it is determined that the difference between the last-time-output number of remaining days and the calculated predicted number of remaining days is greater than the decrease threshold in the above-described fourth embodiment (FIG. 12).

As illustrated in FIG. 16, in “case 4”, the last-time-output number of remaining days is 15 days and is equal to the predetermined threshold of the number of remaining days, which is 15 days. In addition, the difference between the last-time-output number of remaining days, which is 15 days, and the calculated predicted number of remaining days, which is 7 days, is 8 days and is greater than the decrease threshold, which is 5 days. Accordingly, the management apparatus 120 outputs the calculated the predicted number of remaining days, which is 7 days, as the number of remaining days.

In addition, “case 5” illustrates a case where it is determined that the last-time-output number of remaining days is less than or equal to the predetermined threshold of the number of remaining days and where it is determined that the difference between the last-time-output number of remaining days and the calculated predicted number of remaining days is greater than the decrease threshold in the above-described fifth embodiment (FIG. 13).

As illustrated in FIG. 16, in “case 5”, the last-time-output number of remaining days is 15 days and is equal to the predetermined threshold of the number of remaining days, which is 15 days. In addition, the difference between the last-time-output number of remaining days, which is 15 days, and the calculated predicted number of remaining days, which is 7 days, is 8 days and is greater than the decrease threshold, which is 5 days. Accordingly, the management apparatus 120 outputs the alternative number of remaining days, which is 14 days, as the number of remaining days, and outputs a message (“early replacement recommended”). The alternative number of remaining days is obtained by (last-time-output number of remaining days)−1=15−1.

In the above manner, the management apparatus 120 can output the number of remaining days in accordance with the case.

In addition, in the above first to seventh embodiments, the operator 180 judges whether to visit a user on the basis of the output value that is output from the management apparatus 120. However, the method for the operator 180 to view the output value is not limited to this case. For example, the management apparatus 120 may transmit the output value to another system, and the operator 180 may access the other system to view the output value; or the management apparatus 120 may transmit the output value to a terminal of the operator 180, and the operator 180 may view the output value.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Further, in any one of the above-described embodiments, any predetermined value may be previously determined according to the preferences of the operator, for example, based on empirical data.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

1. A management apparatus for managing one or more devices, comprising:
circuitry configured to
acquire information indicating a use history of a device for each predetermined period,
calculate, based on the acquired information indicating the use history, a predicted value indicating operation timing at which an operation is performed on the device, and
output, based on the predicted value, an output value for the predetermined period,
wherein, when an output value that is output for an (N−1)-th time is greater than a threshold, the circuitry outputs, as an N-th-time output value, the predicted value that is calculated for an N-th time, and
wherein, when the output value that is output for the (N−1)-th time is less than or equal to the threshold, the circuitry outputs, as the N-th-time output value, a value that is smaller than or equal to the output value that is output for the (N−1)-th time.

2. The management apparatus according to claim 1,
wherein, when the output value that is output for the (N−1)-th time is less than or equal to the threshold, the circuitry outputs, as the N-th-time output value, a value obtained by subtracting a constant from the output value that is output for the (N−1)-th time.

3. The management apparatus according to claim 1,
wherein, when the output value that is output for the (N−1)-th time is greater than the threshold and the predicted value that is calculated for the N-th time is less than or equal to the threshold, the circuitry outputs, as the N-th-time output value, the threshold.

4. The management apparatus according to claim 1,
wherein, when the output value that is output for the (N−1)-th time is less than or equal to the threshold and a difference between the output value that is output for the (N−1)-th time and the predicted value that is calculated for the N-th time is less than or equal to a predetermined decrease threshold, the circuitry outputs, as the N-th-time output value, a value obtained by subtracting a constant from the output value that is output for the (N−1)-th time, and
wherein, when the output value that is output for the (N−1)-th time is less than or equal to the threshold and the difference between the output value that is output for the (N−1)-th time and the predicted value that is calculated for the N-th time is greater than the predetermined decrease threshold, the circuitry outputs, as the N-th-time output value, the predicted value.

5. The management apparatus according to claim 1,
wherein, when the output value that is output for the (N−1)-th time is less than or equal to the threshold and a difference between the output value that is output for the (N−1)-th time and the predicted value that is calculated for the N-th time is less than or equal to a predetermined decrease threshold, the circuitry outputs, as the N-th-time output value, a value obtained by subtracting a constant from the output value that is output for the (N−1)-th time, and
wherein, when the output value that is output for the (N−1)-th time is less than or equal to the threshold and the difference between the output value that is output for the (N−1)-th time and the predicted value that is calculated for the N-th time is greater than the predetermined decrease threshold, the circuitry outputs, as the N-th-time output value, the value obtained by subtracting a constant from the output value that is output for the (N−1)-th time, and outputs a message.

6. The management apparatus according to claim 1,
wherein, when the predicted value that is calculated for the N-th time is less than or equal to the output value that is output for the (N−1)-th time, the circuitry outputs, as the N-th-time output value, the predicted value, and
wherein, when the predicted value that is calculated for the N-th time is greater than the output value that is output for the (N−1)-th time and the output value that is output for the (N−1)-th time is greater than a threshold, the circuitry outputs, as the N-th-time output value, the predicted value, and
wherein, when the predicted value that is calculated for the N-th time is greater than the output value that is output for the (N−1)-th time and the output value that is output for the (N−1)-th time is less than or equal to the threshold, the circuitry outputs, as the N-th-time output value, a value that is less than or equal to the output value that is output for the (N−1)-th time.

7. The management apparatus according to claim 1,
wherein the circuitry calculates the predicted value by using the number of use days that is calculated by determining a used amount of a day.

8. A management system comprising:
one or more devices; and
the management apparatus according to claim 1, configured to manage the one or more devices.

9. A management system for managing one or more devices, comprising:
circuitry configured to
acquire information indicating a use history of a device for each predetermined period,
calculate, based on the acquired information indicating the use history, a predicted value indicating operation timing at which an operation is performed on the device, and
output, based on the predicted value, an output value for the predetermined period,
wherein, when an output value that is output for an (N−1)-th time is greater than a threshold, the circuitry outputs, as an N-th-time output value, the predicted value that is calculated for an N-th time, and
wherein, when the output value that is output for the (N−1)-th time is less than or equal to the threshold, the circuitry outputs, as the N-th-time output value, a value that is smaller than or equal to the output value that is output for the (N−1)-th time.

10. A management method for managing one or more devices, comprising:
acquiring information indicating a use history of a device for each predetermined period;
calculating, based on the acquired information indicating the use history, a predicted value indicating operation timing at which an operation is performed on the device;
determining whether an output value that is output for an (N−1)-th time is greater than a threshold; and
outputting, based on the predicted value, an output value for the predetermined period;
wherein, when the determining determines that the output value for the (N−1)-th time is greater than a threshold, the outputting outputs the predicted value that is calculated for an N-th time as an N-th-time output value, and
wherein, when the determining determines that the output value for the (N−1)-th time is less than or equal to the threshold, the outputting outputs a value that is smaller than or equal to the output value that is output for the (N−1)-th time as the N-th-time output value.

11. The management method of claim 10,
wherein, when the determining determines that the output value for the (N−1)-th time is less than or equal to the threshold,
the outputting outputs, as the N-th-time output value, a value obtained by subtracting a constant from the output value that is output for the (N−1)-th time.

12. The management method of claim 10, further comprising:
determining whether the predicted value that is calculated for the N-th time is less than or equal to the threshold,
wherein, when the determining determines that the output value for the (N−1)-th time is greater than the threshold, and when the determining determines that the predicted value that is calculated for the N-th time is less than or equal to the threshold,
the outputting includes outputting, as the N-th-time output value, the threshold.

13. The management method of claim 10, further comprising:
determining whether a difference between the output value that is output for the (N−1)-th time and the predicted value that is calculated for the N-th time is less than or equal to a predetermined decrease threshold,
wherein, when the determining determines that the output value for the (N−1)-th time is less than or equal to the threshold and the determining determines that the difference between the output value for the (N−1)-th time and the predicted value for the N-th time is less than or equal to the predetermined decrease threshold,
the outputting includes outputting, as the N-th-time output value, a value obtained by subtracting a constant from the output value that is output for the (N−1)-th time, and
wherein, when the determining determines that the output value for the (N−1)-th time is less than or equal to the threshold and the determining determines that the difference between the output value for the (N−1)-th time and the predicted value for the N-th time is greater than the predetermined decrease threshold,
the outputting includes outputting, as the N-th-time output value, the predicted value.

14. The management method of claim 10, further comprising:
determining whether a difference between the output value for the (N−1)-th time and the predicted value for the N-th time is less than or equal to a predetermined decrease threshold,
wherein, when the determining determines that the output value for the (N−1)-th time is less than or equal to the threshold, and when the determining determines that the difference between the output value for the (N−1)-th time and the predicted value for the N-th time is less than or equal to the predetermined decrease threshold,
the outputting includes outputting, as the N-th-time output value, a value obtained by subtracting a constant from the output value that is output for the (N−1)-th time, and
wherein, when the determining determines that the output value for the (N−1)-th time is less than or equal to the threshold, and when the determining determines that the difference between the output value that is output for the (N−1)-th time and the predicted value that is calculated for the N-th time is greater than the predetermined decrease threshold,
the outputting includes outputting, as the N-th-time output value, the value obtained by subtracting a constant from the output value that is output for the (N−1)-th time, and outputting a message.

15. The management method of claim 10, further comprising:
determining whether that the predicted value that is calculated for the N-th time is less than or equal to the output value that is output for the (N−1)-th time; and
determining whether the output value that is output for the (N−1)-th time is greater than a threshold,
wherein, when the determining determines that the predicted value that is calculated for the N-th time is less than or equal to the output value that is output for the (N−1)-th time,
the outputting includes outputting, as the N-th-time output value, the predicted value, and
wherein, when the determining determines that the predicted value that is calculated for the N-th time is greater than the output value that is output for the (N−1)-th time, and when the determining determines that the output value that is output for the (N−1)-th time is greater than the threshold,
the outputting includes outputting, as the N-th-time output value, the predicted value, and
wherein, when the determining determines that the predicted value that is calculated for the N-th time is greater than the output value that is output for the (N−1)-th time, and the determining determines that the output value that is output for the (N−1)-th time is less than or equal to the threshold,
the outputting includes, outputting, as the N-th-time output value, a value that is less than or equal to the output value that is output for the (N−1)-th time.
